(19) United States
(12) Patent Application Publication
(10) Pub. No.: US 2016/0018637 A1
(43) Pub. Date: Jan. 21, 2016

(54) DISPLAY APPARATUS INCORPORATING OPTICALLY INACTIVE DISPLAY ELEMENTS

(71) Applicant: Pixtronix, Inc., San Diego, CA (US)

(72) Inventors: Andrew William Sparks, Cambridge, MA (US); Wilhelmus Adrianus De Groot, Palo Alto, CA (US)

(21) Appl. No.: 14/332,049

(22) Filed: Jul. 15, 2014

(51) Int. Cl. G02B 26/04; G09G 3/34

(52) U.S. Cl. CPC G02B 26/04; G09G 3/348; G09G 2310/0264

(57) ABSTRACT

This disclosure provides systems, methods, and apparatus for displaying images on a display. An image-forming region is formed by a plurality of display elements each having a movable shutter component. Images are generated by controlling the shutter component of each of the plurality of display elements to move into open or closed positions depending on a desired light output intensity. Optically inactive display elements are positioned outside of the image-forming region. The position of the movable shutter component of each optically inactive display element is selected based on the next state of the movable component of at least one display element. The optically inactive display elements can increase the speed of the shutter components of display elements by displacing a fluid that surrounds the display elements and the optically inactive display elements.

### TECHNICAL FIELD

This disclosure relates to the field of imaging displays, and in particular to image formation processes for field sequential color (FSC) displays.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including a rear substrate, a front substrate positioned in front of the rear substrate, and a seal coupling the rear substrate and the front substrate. The apparatus also can include an array of display elements positioned between the front substrate and the rear substrate to form an image-forming region. Each display element can include a movable component. The apparatus can include a plurality of optically inactive display elements positioned outside of the image-forming region. Each optically inactive display element can include a movable component. The apparatus can include a fluid surrounding the display elements and the optically inactive display elements and filling a volume defined by the rear substrate, the front substrate, and the seal. The apparatus can include a controller. The controller can be capable of obtaining a next state for each display element based on image data, determining a next state for each optically inactive display element based on the next state of at least one display element, and outputting control signals capable of causing the movable components of each display element and each optically inactive display element to move into the respective next state.

In some implementations, the optically inactive display elements can be capable of being optically dark regardless of the state of their respective movable components. In some implementations, a shape of the movable components of the display elements is substantially identical to a shape of the movable components of the optically inactive display elements. In some implementations the fluid can be an electrically non-conductive oil.

In some implementations, the optically inactive display elements can be positioned away from the seal by a distance in the range of about 0.1 millimeters to about 4 centimeters. The front substrate can be separated from the rear substrate by a distance in the range of about 7 microns to about 15 microns.

In some implementations, the display elements and optically inactive display elements can be arranged in rows and columns along an axes of the apparatus. The movable components of each display element and each optically inactive display element can be capable of moving substantially parallel to the axis or substantially perpendicular to the axis. In some implementations, the optically inactive display elements can be positioned at ends of each row or column on either side of the image-forming region. Each row or column can include 1 to about 15 optically inactive display elements on either side of the image-forming region.

In some implementations, for each optically inactive display element, the next state of the optically inactive display element can be selected to be the same as the next state of the display element closest to the optically inactive display element. In some implementations, for each optically inactive display element, the next state of the optically inactive display element is selected based on an average of the next states of the two or more display elements closest to the optically inactive display element. The optically inactive display elements can be capable of being actuated earlier than the display elements.

In some implementations, the apparatus can be included in a display. The apparatus can include a processor that is capable of communicating with the display and capable of processing image data. The apparatus also can include a memory device that is capable of communicating with the processor. In some implementations, the apparatus can include a driver circuit capable of sending at least one signal to the display and a controller capable of sending at least a portion of the image data to the driver circuit. The apparatus also can include an image source module capable of sending the image data to the processor. The image source module can include a receiver, a transceiver, and/or a transmitter. In some implementations, the apparatus can include an input device capable of receiving input data and communicating the input data to the processor.

Another innovative aspect of the subject matter described in this disclosure can be implemented in a method for displaying an image on a display apparatus. The method can include providing an array of display elements forming an image-forming region. Each display element can include a movable component capable of controlling a light output intensity. The method can include providing a plurality of optically inactive display elements positioned at the perimeter of the image-forming region. The method can include, for each display element, controlling the movable component of the display element to move into a closed state or an open state to control an output light intensity corresponding to a pixel of the image. The method can include, for each optically inactive display element, controlling the movable component of the optically inactive display element to move into a first state or a second state based on a next state of at least one display element.

In some implementations, the display elements and optically inactive display elements can be arranged in rows and columns aligned with axes of the display apparatus. The method can include, for each optically inactive display element, controlling the movable component to move into a first state or a second state based on an average of the next states of two or more display elements closest to the optically inactive display element. In some implementations, controlling the movable component of each optically inactive display element can include controlling the movable component to displace a fluid surrounding the display elements and the optically inactive display elements away from an adjacent display element.

Another innovative aspect of the subject matter described in this disclosure can be implemented in an apparatus including a rear substrate, a front substrate positioned in front of the rear substrate, and a seal coupling the rear substrate and the front substrate. The apparatus also can include an array of display elements positioned between the front substrate and the rear substrate to form an image-forming region. Each display element can include a movable component. The apparatus can include a fluid surrounding the display elements and filling a volume defined by the rear substrate, the front substrate, and the seal. The apparatus can include a fluid displacement means for displacing the fluid to reduce a force experienced by the movable component of at least one display element. In some implementations, the apparatus can include a controller capable of determining a next state for the fluid displacement means based on a next state of the at least one display element.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a block diagram of an example display apparatus.

FIG. 4 shows a block diagram of example control logic suitable for use as, for example, the control logic in the display apparatus shown in FIG. 3.

FIG. 5 shows a flow diagram of an example method for generating an image on a display using the control logic shown in FIG. 4.

FIG. 6A shows an example shutter-based display element in an open position.

FIG. 6B shows the example shutter-based display element shown in FIG. 6A in a closed position.

FIG. 6C shows a cross-sectional view of the example shutter-based display element shown in FIG. 6B.

FIG. 7 shows a graph of the damping forces on each example display element in a column of display elements in a simulated display as a function of the position of each display element within the column.

FIG. 8A shows an example array of display elements.

FIG. 8B shows a second example array of display elements.

FIG. 9A shows an example top view of a portion of a display.

FIG. 9B shows another example top view of a portion of a display.

FIG. 10 shows a graph of the damping forces on display elements in an example display incorporating various numbers of optically inactive display elements at the edge of the display.

FIG. 11 shows a flow diagram of an example method for displaying an image on a display apparatus.

FIGS. 12A and 12B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

MEMS displays can incorporate shutter-based display elements positioned between two substrates. The substrates can be joined by a seal, and the volume defined by the substrates and the seal can be filled by a substantially incompressible fluid which can surround the display elements. The shutter speed of display elements at the edge of an image-forming area can be affected by the proximity of the display elements to the edge of the display. For example, fluid forces from the substantially incompressible fluid can be greater on the shutters of display elements in closer proximity to the edge of the display (i.e., closer to the seal joining the two substrates). To make this behavior less pronounced, a space can be left between the edge of the display and the first and last display elements in each row or column. Alternatively, the distance between the substrates, sometimes called the cell gap, can be increased to reduce fluid forces acting on the shutters of the display elements at the edge of the display. However, these solutions can be insufficient to adequately counter the reduction in speed experienced by shutters located close to the display edge and also can result in decreased optical quality of the display. In addition, increasing the dimension of the display in this way can require an increased bezel size for the display.

Some display apparatus can include both image-forming display elements (corresponding to image pixels) as well as a plurality of non-image-forming display elements, sometimes referred to as dummy display elements or optically inactive display elements, to reduce the fluid forces on the shutters of image-forming display elements at the edge of the image-forming region. Optically inactive display elements are display elements that can resemble the image-forming display elements but that do not contribute to the formation of an image. Thus, the light exiting the display to form an image is substantially independent of the states of the optically inactive display elements. Despite not contributing to the formation of an image, the optically inactive display elements are electromechanically active. That is, they include moving components that are electromechanically controlled and actuated.

The optically inactive display elements can be positioned outside of the image-forming region between the perimeter of the image-forming region and the edge of the display. Shutters included in the optically inactive display elements can be driven to displace the substantially incompressible fluid out of the way of the shutters included in the image-forming display elements. For example, in some implementations the shutters of the optically inactive display elements can be driven in the same direction as the shutters of nearby image-forming display elements to reduce the fluid forces acting on the shutters of the image-forming display elements. In some other implementations, the shutters of the optically inactive display elements can be driven in a direction perpendicular to the direction of the shutters of nearby-image-forming display elements to reduce static pressure on the display elements. In some implementations, each column of display elements may contain more than one optically inactive display element. The optically inactive display elements can be capable of being optically dark regardless of the position of their respective shutters.

Particular implementations of the subject matter described in this disclosure can be implemented to realize one or more of the following potential advantages. By incorporating optically inactive display elements outside of an image-forming region of a display, the fluid forces acting on image-forming display elements at or near the edges of the image-forming region can be reduced. Therefore, the shutter speed of the image-forming display elements can be made more uniform across the area of the image-forming region. Incorporating optically inactive display elements also can allow for a narrower cell gap. Narrower cell gaps can result in increased fluid resistance on the shutters of image forming display elements, as the fluid surrounding the shutters has less room to be displaced in response to shutter movement. The inclusion of optically inactive display elements can help to reduce this increased fluid resistance on image-forming display elements, allowing for a narrower cell gap without, or at least with reduced, negative impact on shutter operation. Incorporating optically inactive display elements also can allow for display apparatus with reduced bezel sizes. One way of mitigating fluid resistance on display elements near the edge of the display is to include a wider display bezel to provide additional room for fluid displaced by the shutters in such display elements to move. Incorporating optically inactive display elements at the edge of the display can mitigate the need for this increased bezel size. As such, incorporating optically inactive display elements into a display can allow for a thinner display with a smaller bezel, while maintaining high optical quality. Optically inactive display elements can also allow for greater uniformity of shutter speed for the image-forming display elements.

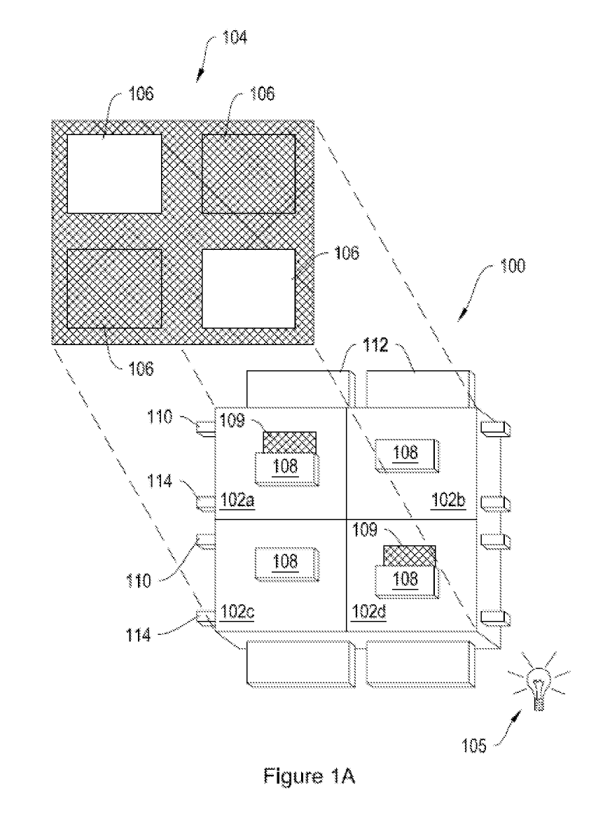

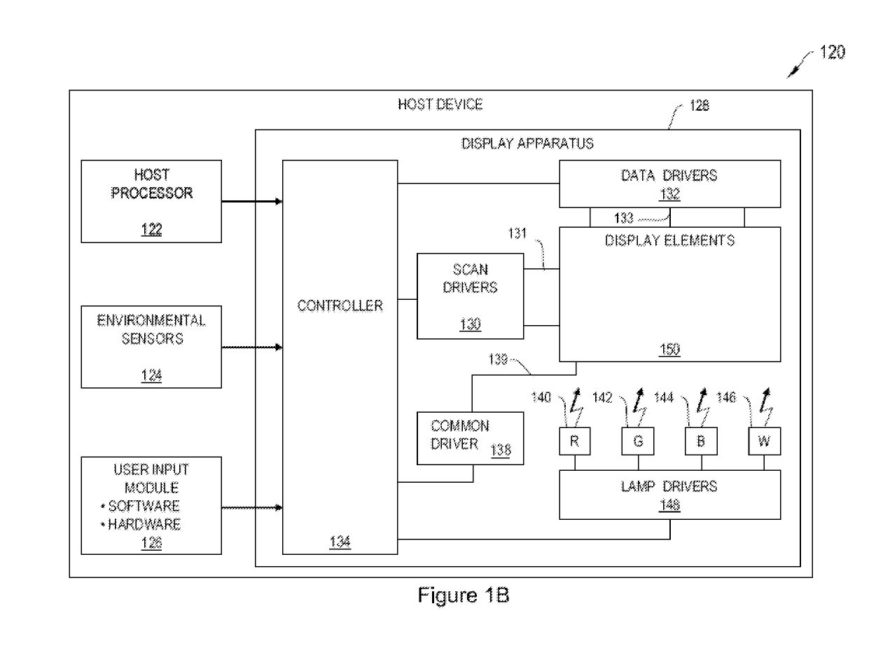

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

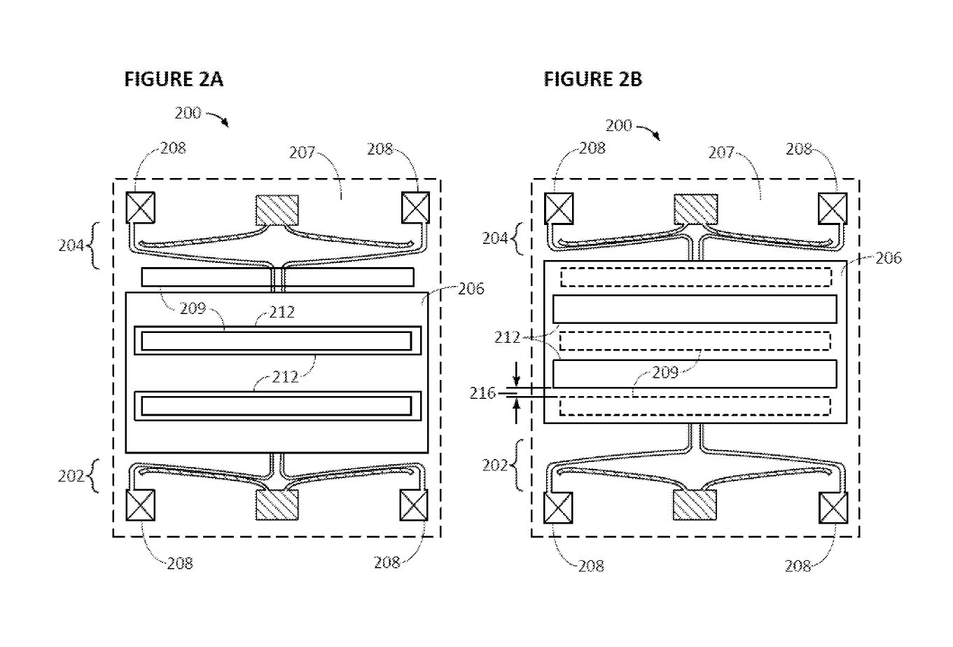

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage V.

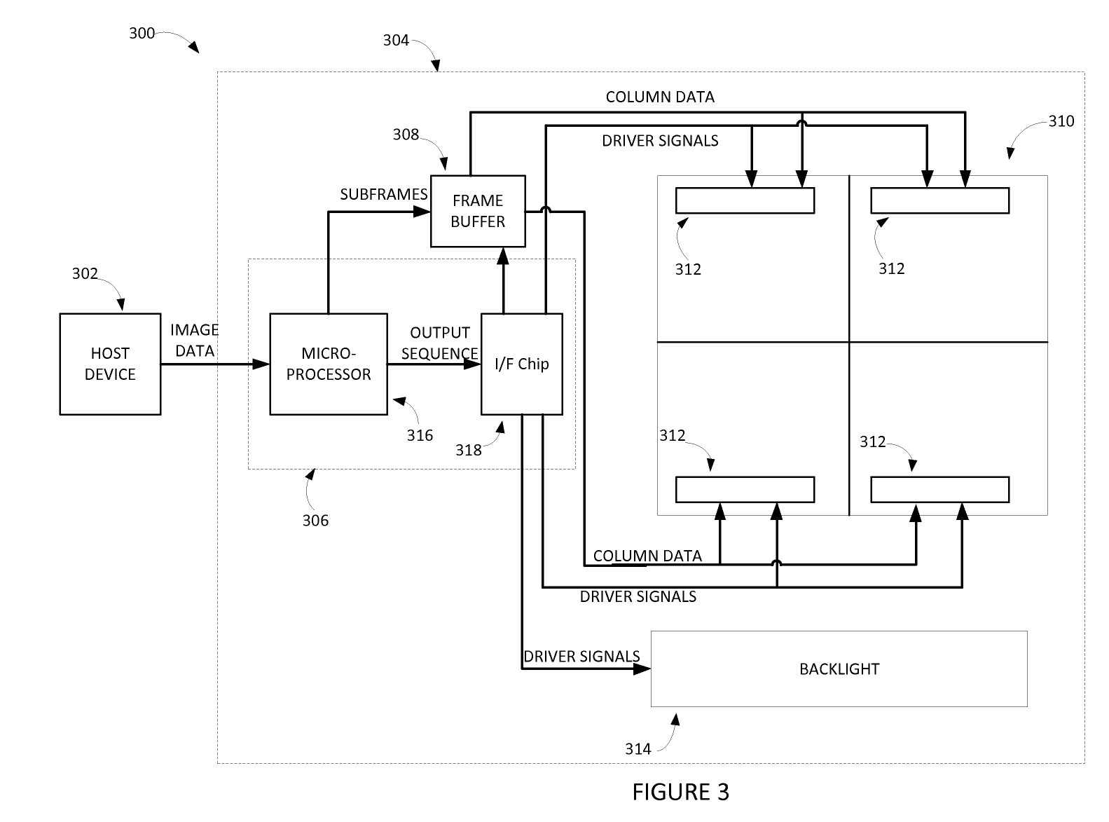

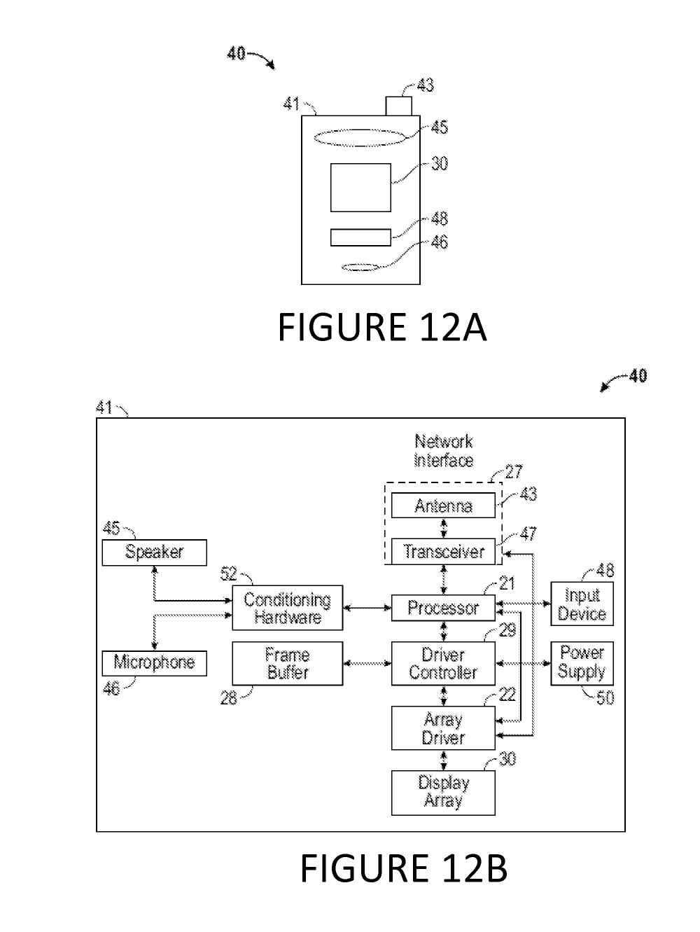

FIG. 3 shows a block diagram of an example display apparatus 300. The display apparatus 300 includes a host device 302 and a display module 304. The host device 302 can be any of a number of electronic devices, such as a portable telephone, a smartphone, a watch, a tablet computer, a laptop computer, a desktop computer, a television, a set top box, a DVD or other media player, or any other device that provides graphical output to a display, similar to the display device 41 shown in FIGS. 12A and 12B below. In general, the host device 302 serves as a source for image data to be displayed on the display module 304.

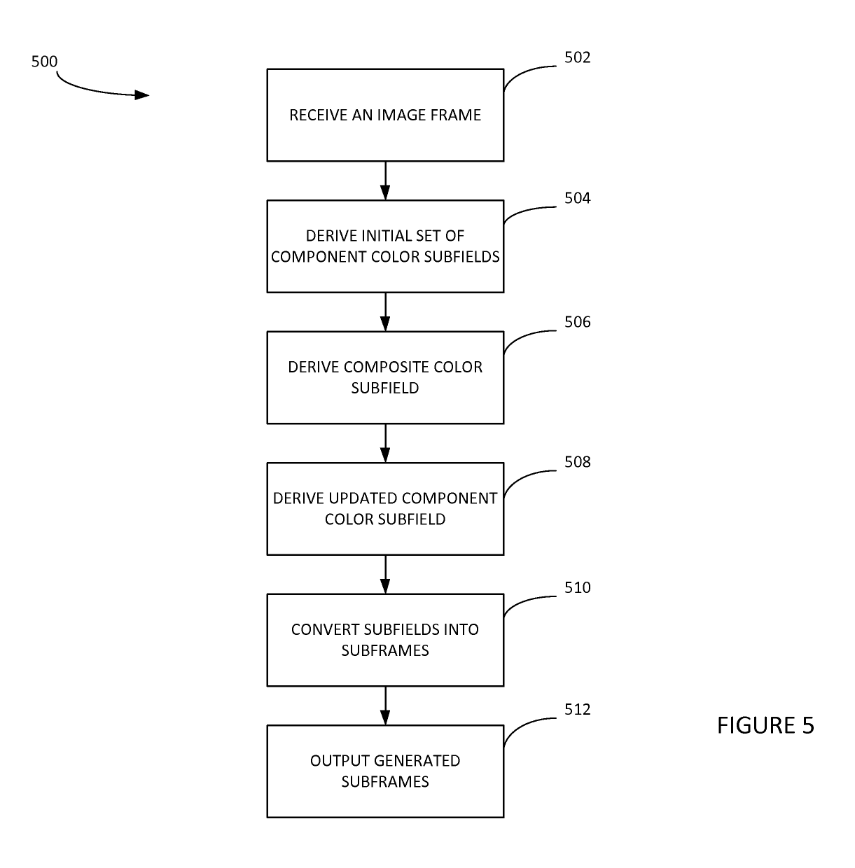

The display module 304 further includes control logic 306, a frame buffer 308, an array of display elements 310, display drivers 312 and a backlight 314. In general, the control logic 306 serves to process image data received from the host device 302 and controls the display drivers 312, array of display elements 310 and backlight 314 to together produce the images encoded in the image data. The control logic 306, frame buffer 308, array of display elements 310, and display drivers 312 shown in FIG. 3 can be similar, in some implementations, to the driver controller 29, frame buffer 28, display array 30, and array drivers 22 shown in FIGS. 12A and 12B, below. The functionality of the control logic 306 is described further below in relation to FIG. 5.

In some implementations, as shown in FIG. 3, the functionality of the control logic 306 is divided between a microprocessor 316 and an interface (I/F) chip 318. In some implementations, the interface chip 318 is implemented in an integrated circuit logic device, such as an application specific integrated circuit (ASIC). In some implementations, the microprocessor 316 is configured to carry out all or substantially all of the image processing functionality of the control logic 306. In addition, the microprocessor 316 can be configured to determine an appropriate output sequence for the display module 304 to use to generate received images. For example, the microprocessor 316 can be configured to convert image frames included in the received image data into a set of image subframes. Each image subframe can be associated with a color and a weight, and includes desired states of each of the display elements in the array of display elements 310. The microprocessor 316 also can be configured to determine the number of image subframes to display to produce a given image frame, the order in which the image subframes are to be displayed, timing parameters associated with addressing the display elements in each subframe, and parameters associated with implementing the appropriate weight for each of the image subframes. These parameters may include, in various implementations, the duration for which each of the respective image subframes is to be illuminated and the intensity of such illumination. The collection of these parameters (i.e., the number of subframes, the order and timing of their output, and their weight implementation parameters for each subframe) can be referred to as an “output sequence.”

The interface chip 318 can be capable of carrying out more routine operations of the display module 304. The operations may include retrieving image subframes from the frame buffer 308 and outputting control signals to the display drivers 312 and the backlight 314 in response to the retrieved image subframe and the output sequence determined by the microprocessor 316. In some other implementations, the functionality of the microprocessor 316 and the interface chip 318 are combined into a single logic device, which may take the form of a microprocessor, an ASIC, a field programmable gate array (FPGA) or other programmable logic device. For example, the functionality of the microprocessor 316 and the interface chip 318 can be implemented by a processor 21 shown in FIG. 12B. In some other implementations, the functionality of the microprocessor 316 and the interface chip 318 may be divided in other ways between multiple logic devices, including one or more microprocessors, ASICs, FPGAs, digital signal processors (DSPs) or other logic devices.

The frame buffer 308 can be any volatile or non-volatile integrated circuit memory, such as DRAM, high-speed cache memory, or flash memory (for example, the frame buffer 308 can be similar to the frame buffer 28 shown in FIG. 12B). In some other implementations, the interface chip 318 causes the frame buffer 308 to output data signals directly to the display drivers 312. The frame buffer 308 has sufficient capacity to store color subfield data and subframe data associated with at least one image frame. In some implementations, the frame buffer 308 has sufficient capacity to store color subfield data and subframe data associated with a single image frame. In some other implementations, the frame buffer 308 has sufficient capacity to store color subfield data and subframe data associated with at least two image frames. Such extra memory capacity allows for additional processing by the microprocessor 316 of image data associated with a more recently received image frame while a previously received image frame is being displayed via the array of display elements 310.

In some implementations, the display module 304 includes multiple memory devices. For example, the display module 304 may include one memory device, such as a memory directly associated with the microprocessor 316, for storing subfield data, and the frame buffer 308 is reserved for storage of subframe data.

The array of display elements 310 can include an array of any type of display elements that can be used for image formation. In some implementations, the display elements can be EMS light modulators. In some such implementations, the display elements can be MEMS shutter-based light modulators similar to those shown in FIGS. 2A or 2B. In some other implementations, the display elements can be other forms of light modulators, including liquid crystal light modulators, other types of EMS- or MEMS-based light modulators, or light emitters, such as OLED emitters, configured for use with a time division gray scale image formation process.

The display drivers 312 can include a variety of drivers depending on the specific control matrix used to control the display elements in the array of display elements 310. In some implementations, the display drivers 312 include a plurality of scan drivers similar to the scan drivers 130, a plurality of data drivers similar to the data drivers 132, and a set of common drivers similar to the common drivers 138, all shown in FIG. 1B. As described above, the scan drivers output write enabling voltages to rows of display elements, while the data drivers output data signals along columns of display elements. The common drivers output signals to display elements in multiple rows and multiple columns of display elements.

In some implementations, particularly for larger display modules 304, the control matrix used to control the display elements in the array of display elements 310 is segmented into multiple regions. For example, the array of display elements 310 shown in FIG. 3 is segmented into four quadrants. A separate set of display drivers 312 is coupled to each quadrant. Dividing a display into segments in this fashion can reduce the propagation time needed for signals output by the display drivers to reach the furthest display element coupled to a given driver, thereby decreasing the time needed to address the display. Such segmentation also can reduce the power requirements of the drivers employed.

In some implementations, the display elements in the array of display elements can be utilized in a direct-view transmissive display. In direct-view transmissive displays, the display elements, such as EMS light modulators, selectively block light that originates from a backlight, such as the backlight 314, which is illuminated by one or more lamps. Such display elements can be fabricated on transparent substrates, made, for example, from glass. In some implementations, the display drivers 312 are coupled directly to the glass substrate on which the display elements are formed. In such implementations, the drivers are built using a chip-on-glass configuration. In some other implementations, the drivers are built on a separate circuit board and the outputs of the drivers are coupled to the substrate using, for example, flex cables or other wiring.

The backlight 314 can include a light guide, one or more light sources (such as LEDs), and light source drivers. The light sources can include light sources of multiple colors, such as red, green, blue, and in some implementations white. The light source drivers are capable of individually driving the light sources to a plurality of discrete light levels to enable illumination gray scale and/or content adaptive backlight control (CABC) in the backlight. In addition, lights of multiple colors can be illuminated simultaneously at various intensity levels to adjust the chromaticities of the component colors used by the display, for example to match a desired color gamut. Lights of multiple colors also can be illuminated to form composite colors. For displays employing red, green, and blue component colors, the display may utilize a composite color white, yellow, cyan, magenta, or any other color formed from a combination of two or more of the component colors.

The light guide distributes the light output by light sources substantially evenly beneath the array of display elements 310. In some other implementations, for example for displays including reflective display elements, the display apparatus 300 can include a front light or other form of lighting instead of a backlight. The illumination of such alternative light sources can likewise be controlled according to illumination gray scale processes that incorporate content adaptive control features. For ease of explanation, the display processes discussed herein are described with respect to the use of a backlight. However, it would be understood by a person of ordinary skill that such processes also may be adapted for use with a front light or other similar form of display lighting.

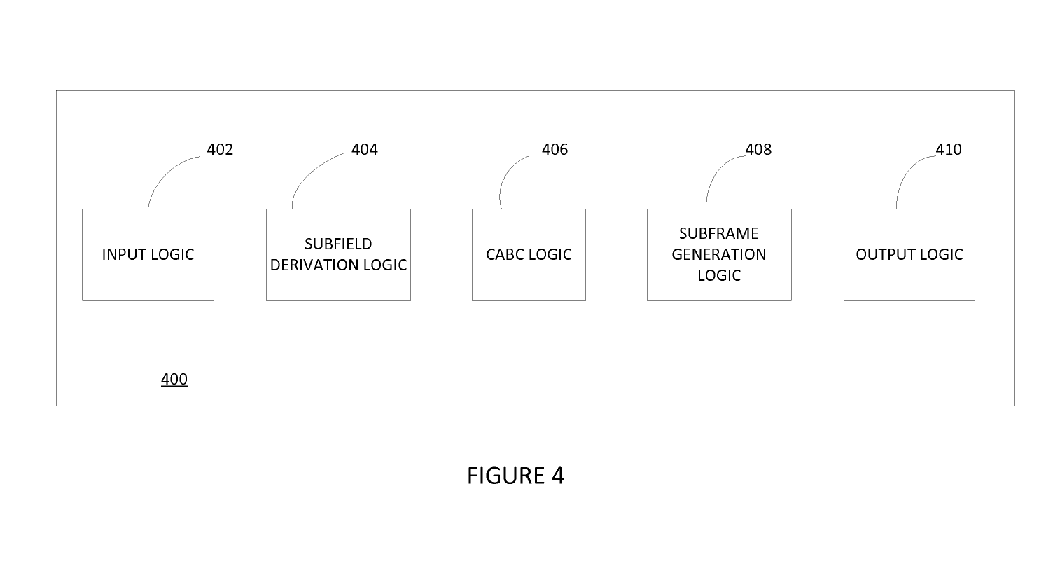

FIG. 4 shows a block diagram of example control logic 400 suitable for use as, for example, the control logic 306 in the display apparatus 300 shown in FIG. 3. More particularly, FIG. 4 shows a block diagram of functional modules executed by the microprocessor 316 and the I/F Chip 318. Each functional module can be implemented as software in the form of computer executable instructions stored on a tangible computer readable medium, which can be executed by the microprocessor 316 and/or as logic circuitry incorporated into the I/F Chip 318. The control logic 400 includes subfield derivation logic 402, subframe generation logic 404, and output logic 406. While shown as separate functional modules in FIG. 4, in some implementations, the functionality of two or more of the modules may be combined into one or more larger, more comprehensive modules. Together the components of the control logic 400 function to carry out a method for generating an image on a display.

FIG. 5 shows flow diagram of an example method 500 for generating an image on a display using the control logic 400 shown in FIG. 4. The method 500 includes receiving an image frame (stage 502), deriving an initial set of component color subfields (stage 504), deriving a composite color subfield (stage 506), deriving updated component color subfields (stage 508), converting the derived subfields into subframes (stage 510) and outputting the subframes (stage 512) to display the image.

The method 500 begins with the subfield derivation logic 402 receiving data associated with an image frame (stage 502). Typically, such image data is obtained as a stream of intensity values for the red, green, and blue components of each pixel in the image frame. The intensity values typically are received as binary numbers.

The subfield derivation logic 402 can derive and store an initial set of component color subfields for the image frame based on the received image data (stage 504). Each color subfield includes for each pixel in the display an intensity value indicating the amount of light to be transmitted by that pixel, for that color, to form the image frame. A component color subfield refers to a subfield associated with a color that forms one of the vertices of the color gamut (represented in the x, y or other color space) reproduced by the display. For example, in the CIE 1931 color space, the component colors would be red, green, and blue.

In some implementations, the subfield derivation logic 402 derives the initial set of component color subfields (stage 504) by segregating the pixel intensity values for each primary color represented in the received image data (i.e., red, green, and blue). In some implementations, one or more image preprocessing operations, such as gamma correction and dithering, also may be carried out by the subfield derivation logic 402 prior to, or in the process of, deriving the initial set of component color subframes (stage 504).

The subfield derivation logic 402 can derive a composite color subfield (stage 506) based on the initial set of component color subframes. A composite color subfield is a subfield associated with a composite color. Examples of such composite colors include white, yellow, cyan, magenta, orange, or any other color formed by combining two or more of a display's component colors to equal or varying degrees. In some implementations, the composite color is selected for each image frame base on the contents of that image and/or one or more previous image frames. In general, displaying an image using a composite color can help mitigate color break-up (CBU) image artifacts and, in some cases, can reduce the power consumed by the display in generating images.

In some implementations in which the composite color subfield is a white subfield, the subfield derivation logic 402 derives the composite color subfield by identifying for each pixel the minimum of the intensity values associated with that pixel in the component color subfields. For example, consider a pixel having component color pixel intensity values of {R, G, B}={150, 100, 50}, where R corresponds to red, G corresponds to green, and B corresponds to blue. For such a pixel, the subfield derivation logic 402 would set the intensity value for the pixel in a white composite color subfield to 50. In some other implementations, the subfield derivation logic 402 sets the intensity value for a pixel in the composite color subfield to a fraction (such as 25%, 33%, 50%, 60%, 75%, etc.) of the minimum of the component color intensity values for the pixel.

The subfield derivation logic 402 can derive an updated set of component color subfields (stage 508) based on the derived composite color subfield. More particularly, the subfield derivation logic 402 reduces the intensity values in the component color subfields to account for any light energy being output through the composite color subfield. For example, for the pixel discussed above with input pixel intensity values of {R, G, B}={150, 100, 50}, and a composite color intensity value {W}={50}, the subfield derivation logic 402 reduces the intensity values in each of the component color subfields by 50. The resulting set of intensity values for the pixel in each of the four subfields is {R, G, B, W}={100, 50, 0, 50}.

In some implementations, additional processing may be carried out on a derived subfield prior to generation of subframes. For example, in some implementations, the CABC logic 406 is configured to generate CABC-adjusted subfields. In implementing CABC, pixel intensity values associated with a subfield are scaled up while the output intensity of the backlight for illuminating that subfield is scaled down. The scaling down of the output intensity of the backlight improves the power efficiency of the display apparatus. Moreover, this improved power efficiency is achieved while substantially maintaining image quality. The output intensity of the backlight is typically scaled down by a factor referred to herein as a light source scaling factor F. This light source scaling factor F can be determined in several ways. In particular, two example scaling factors F₁ and F₂ are discussed below.

In some implementations, the light source scaling factor F₁ can be determined using pixel intensity values before and after the application of CABC. In some such implementations, the CABC logic 406 can utilize a CABC lookup table (LUT) to determine CABC-adjusted pixel intensity values. In some such implementations, the CABC-LUT can be populated with a range of CABC-adjusted pixel intensity values for a corresponding range of pixel intensity values. The CABC-adjusted pixel intensity values also may be generated using a CABC-function, such as a polynomial, that can produce a CABC-adjusted pixel intensity value for a given pixel intensity value. The CABC-function can be linear, non-linear, or part linear and part non-linear. Both the CABC-LUT and the CABC-function can ensure that the CABC-adjusted pixel intensity values do not exceed the maximum intensity value that can be displayed in the subfield. For example, if 8-bits are being used to represent a pixel intensity value, then the maximum pixel intensity value cannot exceed 255. Thus, the CABC-LUT and the CABC-function can be configured to ensure that the CABC-adjusted pixel intensity values do not exceed the value 255. In some implementations, the CABC logic 406 can include multiple CABC-LUTs or CABC-functions. The CABC logic 406 selects a CABC-LUT or CABC-function based on one or more characteristics of the input subfield, such as the average pixel intensity value, the maximum intensity value, the median pixel intensity value, etc.

The pixel intensity values prior to applying CABC and the CABC-adjusted pixel intensity values can be used to determine a light source scaling factor F₁ for scaling down the output intensity of the backlight. For example, in some implementations, a scaling factor F₁ can be a ratio of the average pixel intensity value of the derived subfield (i.e., before applying CABC) over the average pixel intensity value of the CABC-adjusted subfield. Typically, the scaling factor F₁ can be less than or equal to one, and can be passed to the output logic 410.

In some implementations, the light source scaling factor F₂ can be determined using the pixel intensity values of the derived subfield itself. In some implementations, the scaling factor F₂ for each color is the same and is derived by taking the minimum of the scaling factors F₂ for each color channel. In some such implementations, the derived subfield can scaled up and the output intensity of the backlight can be scaled down by the same scaling factor, F₂. For example, the CABC-adjusted subfield can be generated by identifying a highest pixel intensity value in a subfield and scaling all the pixel values in the subfield such that the pixel value of the pixel with the highest intensity level is equal to the maximum intensity value used by the display. For example, if the pixel intensity values for a color subfield range from 0 to 255, and the highest pixel intensity value in that subfield is 150, then the CABC logic 406 determines the light source scaling factor, F₂, as a ratio of the highest pixel intensity value (150) over the maximum intensity value (255). That is, the light source scaling factor F₂ equals 150/255. The CABC logic 406 multiplies all the pixel intensity values in the color subfield by the inverse of the scaling factor F₂ to generate CABC-adjusted pixel intensity values. For example, if a pixel intensity value is equal to 100, then the CABC logic 406 multiplies 100 by I/F₂ (or, using the above example, by 255/150) to generate the corresponding CABC-adjusted pixel intensity value. In this manner, all the pixel intensity values in the subfield are scaled up by the inverse of the light source scaling factor F₂, and the output intensity of the backlight is scaled down by the light source scaling factor F₂. As mentioned above, the scaling down of the output intensity of the backlight improves the power efficiency of the display apparatus. The CABC-adjusted subfield, scaled up by the scaling factor F₂, can be processed by the subframe generation logic 408.

In some implementations, the scaling factor F may be determined differently than set forth above. For example, in some implementations, the numerator of the ratio representing the scaling factor F discussed above, can be an average or another function of some or all pixel intensity values in the subfield instead of the highest of all pixel values. In some implementations, the denominator can be a value higher than the maximum intensity value a pixel can assume in the subfield. In some other implementations, the scaling factor F may be an arbitrary value independent of the pixel intensity values in the subfield.

Referring back to FIG. 5, the subframe generation logic 408 (shown in FIG. 4) can be implemented to convert the derived subfields into sets of subframes (stage 510). Each subframe corresponds to a particular time slot in a time division gray scale image output sequence. It includes a desired state of each display element in the display for that time slot. In each time slot, a display element can take either a non-transmissive state or one or more states that allow for varying degrees of light transmission. In some implementations, the generated subframes include a distinct state value for each display element in the array of display elements 310.

In some implementations, the subframe generation logic 408 uses a code word lookup table (LUT) to generate the subframes (stage 510). In some implementations the code word LUT stores a series of binary values referred to as code words that indicate a series of display element states that result in a given pixel intensity value. The value of each digit in the code word indicates a display element state (for example, light or dark) and the position of the digit in the code word represents the weight that is to be attributed to the state. In some implementations, the weights are assigned to each digit in the code word such that each digit is assigned a weight that is twice the weight of a preceding digit. In some other implementations, multiple digits of a code word may be assigned the same weight. In some other implementations, each digit is assigned a different weight, but the weights may not all increase according to a fixed pattern, digit to digit.

To generate a set of subframes (stage 510), the subframe generation logic 408 obtains code words for all pixels in a color subfield. The subframe generation logic 408 can aggregate the digits in each of the respective positions in the code words for each pixel together into subframes. For example, the digits in the first position of each code word for each pixel are aggregated into a first subframe. The digits in the second position of each code word for each pixel are aggregated into a second subframe, and so forth. The subframes, once generated, are stored in the frame buffer 308 shown in FIG. 3.

In some other implementations, particularly for implementations using light modulators capable of achieving one or more partially transmissive states, the code word LUT may store code words using base-3, base-4, base-10, or some other base number scheme.

The output logic 410 of the control logic 400 (shown in FIG. 4) can output the generated subframes (stage 512) to display the received image frame. Similar to as described above in relation to FIG. 3 with respect to the I/F chip 318, the output logic 410 outputs cause each subframe to be loaded into the array of display elements 310 (shown in FIG. 3) and illuminated according to an output sequence. In some implementations, the output sequence is capable of being configured, and may be modified based on user preferences, the content of image data being displayed, external environmental factors, etc.

In certain time division gray scale displays, the amount of time some lower weighted subframes would be displayed, if displayed at full backlight intensity, would be less than the amount of time it takes for a subsequent subframe to be loaded into the display. The time interval between the illumination of these lower weighted ceasing and the loading of the next subframe completing is, to some extent, wasted. Moreover, for backlights with LEDs having nonlinear current versus light output curve, displaying subframes for such a short period of time at a high backlight intensity is less energy efficient than displaying the same subframes for longer periods of time (up to the amount of time it takes to address the display for a subsequent subframe) at a lower backlight intensity. Thus extending the duration for which such subframes are illuminated to match the subframe loading time can make for a more energy efficient display. However, doing so can introduce additional image artifacts, such as flicker.

To take advantage of possible energy efficiencies associated with illuminating lower weighted subframes for longer periods of time at lower backlight intensities, without introducing flicker, the illumination period for each subframe can be tailored based on its corresponding color and weight. For example, the human visual system (HVS) is more sensitive to flicker artifacts in green light than in blue or red light. Hence the critical flicker frequency(CFF) (i.e. the lowest frequency at which the HVS begins to perceive flicker) for the green color can often approach, or exceed, the frame rate of the display and therefore cause flicker artifacts. Since flicker perception increases with illumination time, the degree to which the illumination time for lower weighted green subframes can be “stretched” is less than the degree to which lower weighted red and blue subframes can be stretched.

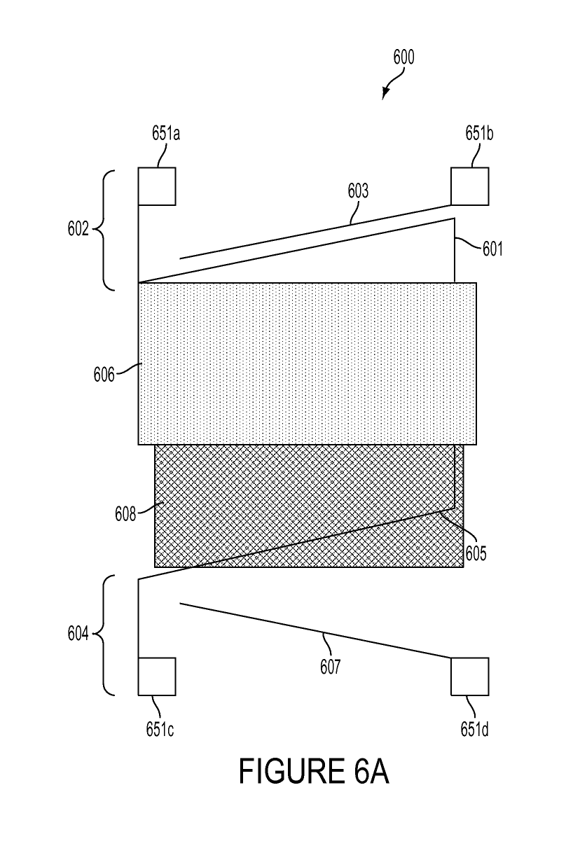

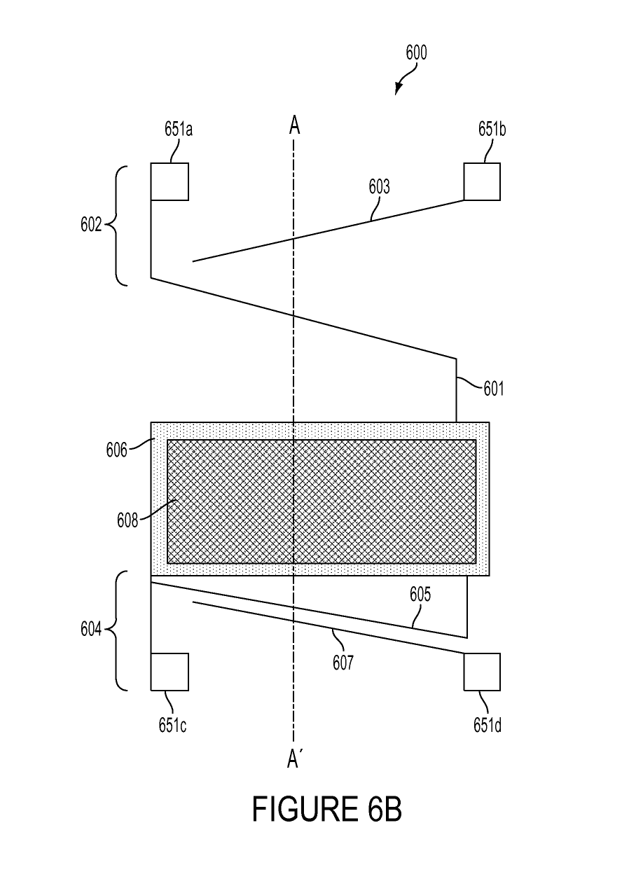

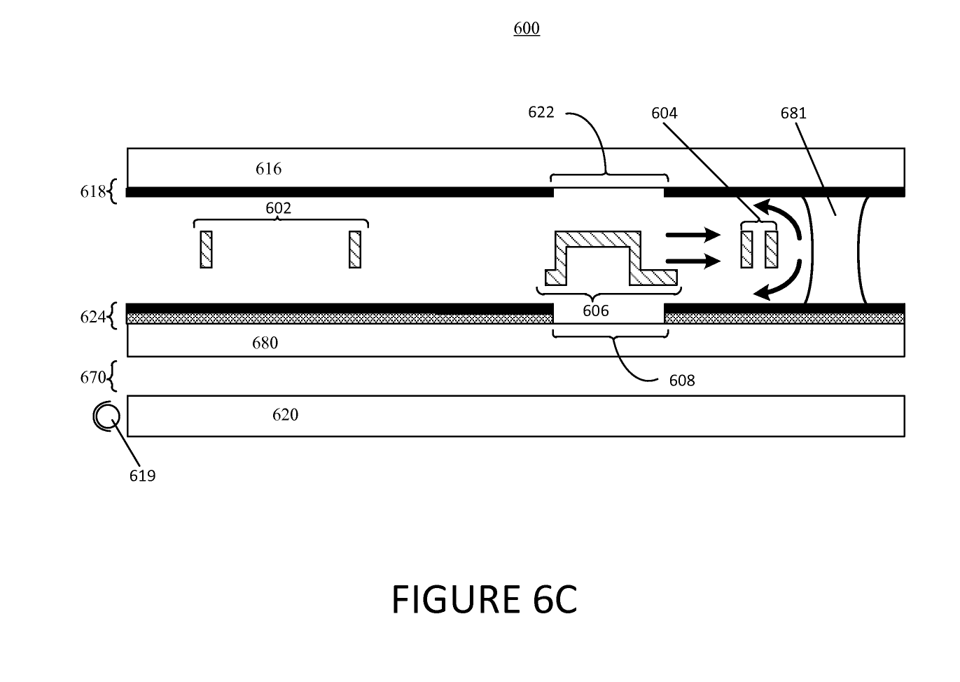

Some display apparatus can include both image-forming display elements (corresponding to image pixels) as well as a plurality of non-image-forming, optically inactive display elements. In some implementations, in generating a set of subframes (stage 510), the subframe generation logic 408 determines information corresponding to desired states of the optically inactive display elements incorporated into the display in addition to the states of the image-forming display elements, as described above. A display may use the optically inactive display elements to improve the performance of image-forming display elements, without the optically inactive display elements directly contributing to the formation of images. Optically inactive display elements and the uses thereof are described further below in connection with FIGS. 6A-11.

Still referring to FIG. 5, the output logic 410 of the control logic 400 (shown in FIG. 4) can output the generated subframes (stage 512) to display the received image frame. As described above in relation to FIG. 3 with respect to the OF chip 318, the output logic 410 outputs cause each subframe to be loaded into the array of display elements 310 (shown in FIG. 3) and illuminated according to an output sequence. In some implementations, the output sequence is configurable, and may be modified based on user preferences, the content of image data being displayed, external environmental factors, etc.

FIG. 6A shows an example shutter-based display element 600 in an open position. The display element 600 includes opposing actuators 602 and 604 coupled to a shutter 606. Each actuator 602 and 604 includes two beams 601 and 603, and 605 and 607, respectively. The display element 600 also includes an aperture 608. The shutter 606 is positioned above the aperture 608.

The actuators 602 and 604 are compliant beam actuators. The actuators 602 and 604 move the shutter 606 in a plane substantially parallel to a surface of a substrate (not shown) over which the shutter 606 is suspended by applying a voltage greater or equal to an actuation voltage across the beams 605 and 607 of the actuator 604 or across the beams 601 and 603 of the actuator 602. The beams 603 and 607 are secured by anchors 651b and 651d, respectively. The shutter 606 is suspended a short distance over the aperture 608 by anchors 651a and 651c, attached to the beams 601 and 605, respectively. The beams 601 and 605 couple to the edges of the shutter 606, confining the motion of the shutter 606 substantially to a plane parallel to the plane of the substrate. In some implementations, the beams 601 and 605 are made from a flexible material that can deform when either of the actuators 602 and 604 is actuated. In some implementations, the actuation of the actuators 602 and 604 can be controlled by a voltage driver. For example, the display element 600 can be an element of the array of light modulators 150 shown in FIG. 1B. The controller 134 can communicate instructions to the voltage driver 138 shown in FIG. 1B, which can then apply actuation voltages to the display element 600. Through such communication, the controller 134 can cause the actuators 602 and 604 of the shutter assembly 600 to achieve a substantially light transmissive state, as shown in FIG. 6A. In this state, no portion of the shutter 606 is positioned over the aperture 608. Therefore, substantially all of the light passing through the aperture 608 is able to escape from the display in which the display element 600 is used.

FIG. 6B shows the example shutter-based display element 600 shown in FIG. 6A in a closed position. The shutter 606 is positioned directly over the aperture 608 so that substantially none of the light passing through the aperture 608 is able to escape from the display in which the display element 600 is used. The shutter 606 is depicted as being partially transparent so that the position of the aperture 608 can be seen beneath the shutter 606. In practice, however, the shutter 606 is opaque, so that light in its path is substantially entirely obstructed.

FIG. 6C shows a cross-sectional view of the example shutter-based display element 600 shown in FIG. 6B. The cross-sectional view shown in FIG. 6C is taken along the line A-A′ shown in FIG. 6B. The shutter 606 is suspended between a front substrate 616 and a rear substrate 680. A seal 681 couples the front substrate 616 to the rear substrate 680 and prevents a substantially incompressible fluid from escaping through the sides of the display. The shutter close actuator 604 and the shutter open actuator 602 are capable of moving the shutter 606 laterally into open and closed positions, in response to actuation voltages.

A front aperture layer 618 couples to the front substrate 616 and defines a front aperture 622. A rear aperture layer 624 is positioned on the front-facing surface of the rear substrate 680. The rear aperture layer 624 defines the aperture 608. When the shutter is in an open position, the front aperture 622 and the rear aperture 608 are unobstructed by the shutter 606. In the closed position shown in FIG. 6C, the shutter 606 is positioned between the front aperture 622 and the rear aperture 608. A light source 619 and a light guide 620 (together forming a backlight) are positioned behind the rear substrate 680. The light guide 620 is separated from the rear substrate 680 by a gap 670. In some implementations, the gap 670 can be filled with air. In some other implementations, the gap 670 can be filled with another fluid or a vacuum. The fluid or vacuum filling the gap 670 can aid in extracting a desired angular distribution of light from the light guide 620.

The shutter 606 can be formed through a MEMS manufacturing process that gives it significant height in the vertical direction. As a result, lateral motion of the shutter 606 in response to the application of an actuation voltage can displace a significant volume of the incompressible fluid. For a display element near the edge of the display (along the axis of motion of the shutter), such as the display element 600 shown adjacent to the seal 681 in FIG. 6C, the fluid resistance experienced by the shutter 606 is substantially greater than the resistance experienced by the shutters of similar display elements positioned farther away from the seal 681. In some implementations, the distance from the shutter 606 to the seal 681 (referred to as the display-to-bond width) may be in the range of about 0.1 millimeters to about 4 centimeters.

The increased fluid resistance at the edge of the display results from the close proximity of the shutter 606 to the edge seal 681, which reduces the space into which the fluid displaced by the shutter can be dispersed when the shutter 606 is moved laterally towards the edge seal 681. Fluid is driven against the edge seal 681 in the direction of the bold arrows shown in FIG. 6C. As the fluid cannot continue to move in the direction of shutter motion, the fluid must be forced around the top, bottom, and sides of the shutter close actuator 604 and the shutter 606 against the flow of fluid driven by the shutter 606. Because of the increased fluid resistance, the shutter 606 tends to move into the closed position more slowly than a similar shutter that is positioned farther from the edge seal 681. Similarly, when the shutter 606 is moved from the closed position to the open position, a reduced fluid pressure is created between the shutter 606 and the edge seal 681, causing a portion of the substantially incompressible fluid to move into the region of reduced fluid pressure. Because the volume between the shutter 606 and the edge seal 681 is small (relative to the volume between the edge seal and the shutters of display elements positioned farther from the edge seal 681), there is less fluid available to fill the region of reduced fluid pressure, which can result in greater resistance experienced by the shutter 606 as it moves away from the edge seal 681.

The relatively slower movement of the shutter 606 at the edge of the display can have a negative effect on the quality of images produced by the display. In some implementations, this effect can be reduced by increasing the cell gap (i.e., the distance between the front substrate 616 and the rear substrate 680). An increased cell gap can provide additional space into which the fluid can be displaced by the shutter 606, thereby decreasing the resistance exerted by the fluid. However, increasing the cell gap can result in decreased optical quality, and also necessitates a thicker display apparatus. The resistance also can be decreased by expanding the display-to-bond width, but this can require a larger bezel size for the display.

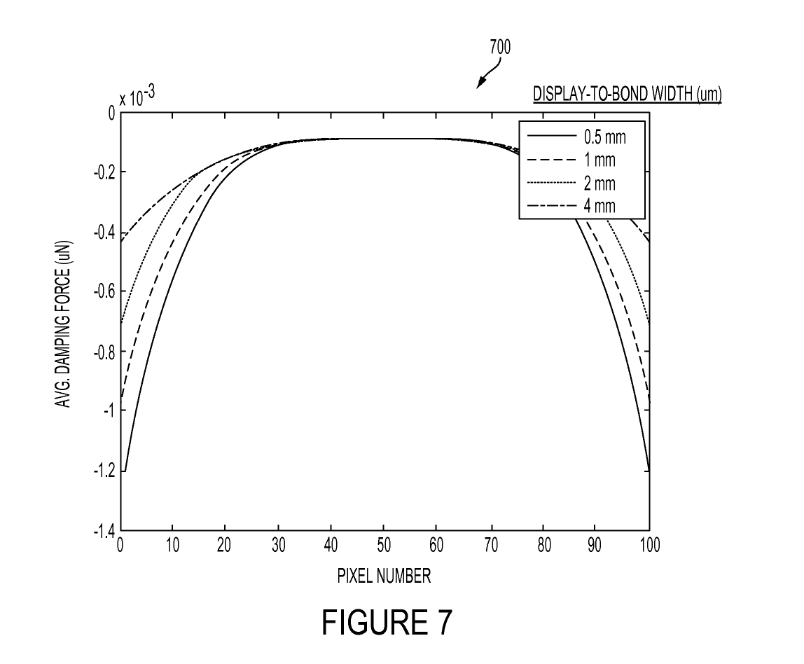

FIG. 7 shows a graph 700 of the damping forces on each example display element in a row of display elements in a simulated display as a function of the position of each display element within the row. Four plots are shown, each corresponding to a different display-to-bond width. The plots are generated under the simplifying assumption that each row has 100 display elements (i.e., display element 1 and display element 100 are at the edges of the display, adjacent to the seal). The graph 700 is based on a simplified two dimensional simulation that represents fluid motion in the plane of the display, and, therefore, ignores the effects of the cell gap. Pixels of 117 microns by 117 microns were simulated with shutters having a frontal length of about 74 microns. The particular values shown in the graph and discussed below are illustrative only, and may be different in other displays with other dimensions. However, the principles illustrated can apply to displays having different numbers of display elements per row or different geometries. The term “row” is used in the description of FIG. 7 to refer to display elements that are adjacent to one another along a horizontal direction, while the term “column” is used to refer to display elements that are adjacent to one another along a vertical direction. However, a person having ordinary skill in the art will readily understand that the terms “row” and “column” may be interchanged without departing from the scope of the disclosure.

As indicated above, the display-to-bond width is the distance from the edge seal to the nearest display element. As shown, the display-to-bond width has virtually no impact on the damping forces experienced by display elements positioned in the middle of each row, which all experience substantially the same damping force of about 0.0002 uN regardless of the display-to-bond width. However, at the edges of the display, the display-to-bond width significantly impacts the damping forces experienced by each display element. Specifically, increased display-to-bond width results in decreased damping forces at the edges of the display. For displays having smaller display-to-bond widths, the damping forces at the edge display elements are significantly higher than the damping forces experienced by display elements near the center of the display. For example, for a display-to-bond width of 500 microns, display elements adjacent to the edge seal experience about 0.0012 uN of damping force on average, as compared to about 0.0002 uN for display elements in the center of the display. The specific damping forces mentioned above are merely illustrative in nature and are based on the specific geometry of the simulated display apparatus for which the data was generated. Display elements in other display apparatus with different geometries or including different fluids may experience different damping forces, and over a variety of damping force ranges.

Incorporating optically inactive display elements at the lateral edge of the display near the seal also can serve as way to substantially reduce the fluid forces acting on the image-forming display elements. The optically inactive display elements can drive fluid out of the way of the image-forming display elements, in order to reduce the resistance experienced by the shutters of the image-forming display elements. In some implementations, optically inactive display elements may include all of the components of the display element 600 (shown in FIGS. 6A-6C). In some other implementations, the optically inactive display elements may be manufactured without the rear aperture 608 and front aperture 622 (shown in FIG. 6C), but can otherwise include all of the components of the display element 600. Eliminating the rear aperture 608 and front aperture 622 can allow the optically inactive display element to remain optically dark regardless of the position of its shutter. Therefore, movement of the shutter of an optically inactive display element will not cause extraneous light to interfere with images produced by the image-forming display elements.

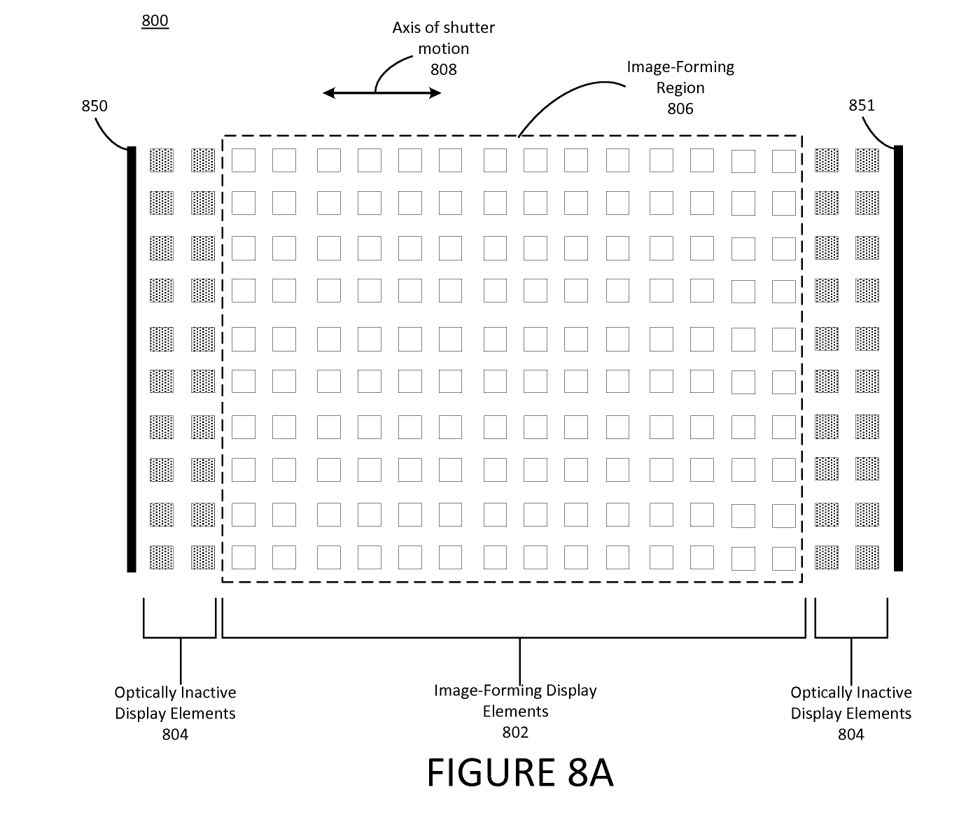

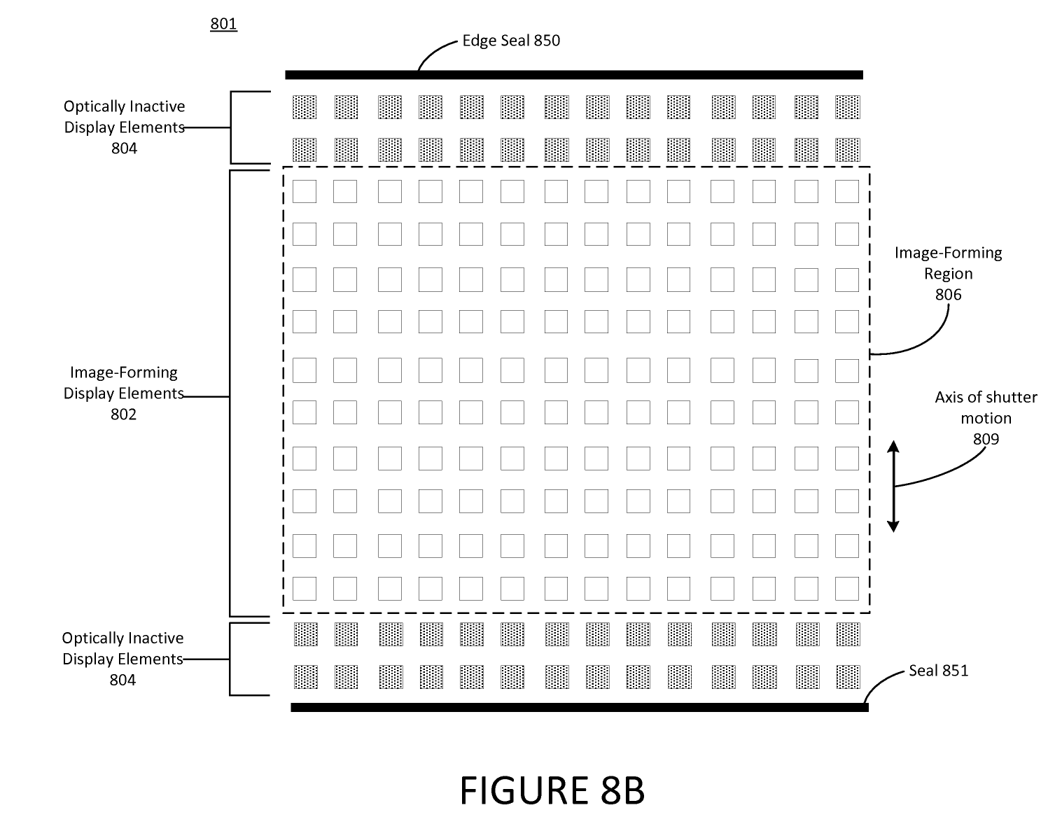

FIG. 8A shows an example array 800 of display elements. The array 800 includes image-forming display elements 802 and optically inactive display elements 804. For illustrative purposes, the image-forming display elements 802 are arranged in a grid pattern having fourteen columns and ten rows. In an actual display, the array 800 could have hundreds (or possibly more than one thousand) of rows and columns. The image-forming display elements 802 define an image-forming region 806 of a display. In some implementations, each image-forming display element 802 can be implemented as a shutter-based light modulator capable of outputting various intensities of light, as described above. The subframe generation logic 408 shown in FIG. 4 can determine whether, for a given subframe, each shutter-based light modulator should be in a light-transmissive or light-obstructing state based on the content of an image to be displayed within the image-forming region 806.

In some implementations, the image-forming display elements 802 and optically inactive display elements 804 are positioned within a volume defined by a front substrate, a rear substrate, and edge seals 850 and 851, which bond the front substrate to the rear substrate (similar to as shown in FIG. 6C). The volume can be filled with a substantially incompressible fluid, such as an oil. In some implementations, the volume is filled with air. As the shutters of the image-forming display elements 802 and optically inactive display elements 804 move along the axis of motion 808 shown in FIG. 8A, they can experience resistance from the substantially incompressible fluid. In some implementations, the shutters of display elements closest to the edge seals 850 and 851 along the axis of motion 808 (i.e., at the perimeter of the display) experience increased resistance relative to the display elements positioned towards the center of the display as explain above in relation to FIG. 6C.

To reduce the resistance acting on the image-forming display elements 802, the optically inactive display elements 804 are positioned outside of the image-forming region 806 between the perimeter of the image-forming region 806 at the edge of the display. The optically inactive display elements 804 can incorporate shutters that can be moved to displace fluid. Therefore, the optically inactive display elements 804 can be used to reduce the resistance experienced by the image-forming display elements 802 near the edge of the image-forming region 806 by moving in coordination with nearby image-forming display elements 802. For example, the optically inactive display elements 804 can displace fluid along the axis of motion 808 of the shutters of nearby image-forming display elements 802, so that the image-forming display elements 802 can move through the fluid while experiencing reduced resistance.

In FIG. 8A, optically inactive display elements 804 are positioned only at the left and right edges of the image-forming region 806. This arrangement is sufficient because the shutters of the image-forming display elements 802 move only left and right and therefore experience fluid resistance substantially only along the left-right axis of motion 808. Optically inactive display elements are therefore unnecessary at the top and bottom edges of the image-forming region 806. However, the orientation and position of the optically inactive display elements 804 relative to the image-forming display elements 802 can be changed to accommodate different axes of shutter motion.

FIG. 8B shows a second example array 801 of display elements. The array 801 includes image-forming display elements 802 and optically inactive display elements 804 configured for motion along a second axis of motion 809. The image-forming display elements 802 again form an image-forming region 806 having, for illustrative purposes, fourteen columns and ten rows. However, in the implementation shown in FIG. 8B, the shutters of the image-forming display elements 802 and the optically inactive display elements 804 move up and down, as opposed to left and right. Therefore, the optically inactive display elements 804 are positioned only at the top and bottom edges of the image-forming region 806 to reduce fluid resistance experienced by the image-forming display elements 802 at those edges. The image-forming display elements 802 at the left and right edges of the image-forming region 806 do not experience significantly increased fluid forces despite their proximity to the edge of the display, because their shutters do not move in a direction opposed to the left or right edges of the display. Therefore no optically inactive display elements are necessary at the left and right edges of the image-forming region 806 shown in FIG. 8B.

While both FIGS. 8A and 8B show two rows or columns, respectively, of optically inactive display elements 804 on each side of the arrays 800 and 801, it should be understood that any number of optically inactive display elements 804 may be used. For example, in some implementations, a single row or column of optically inactive display elements 804 may be used on each edge of the display. In other implementations, each edge of the display may include up to 30 or more rows or columns of optically inactive display elements 804.

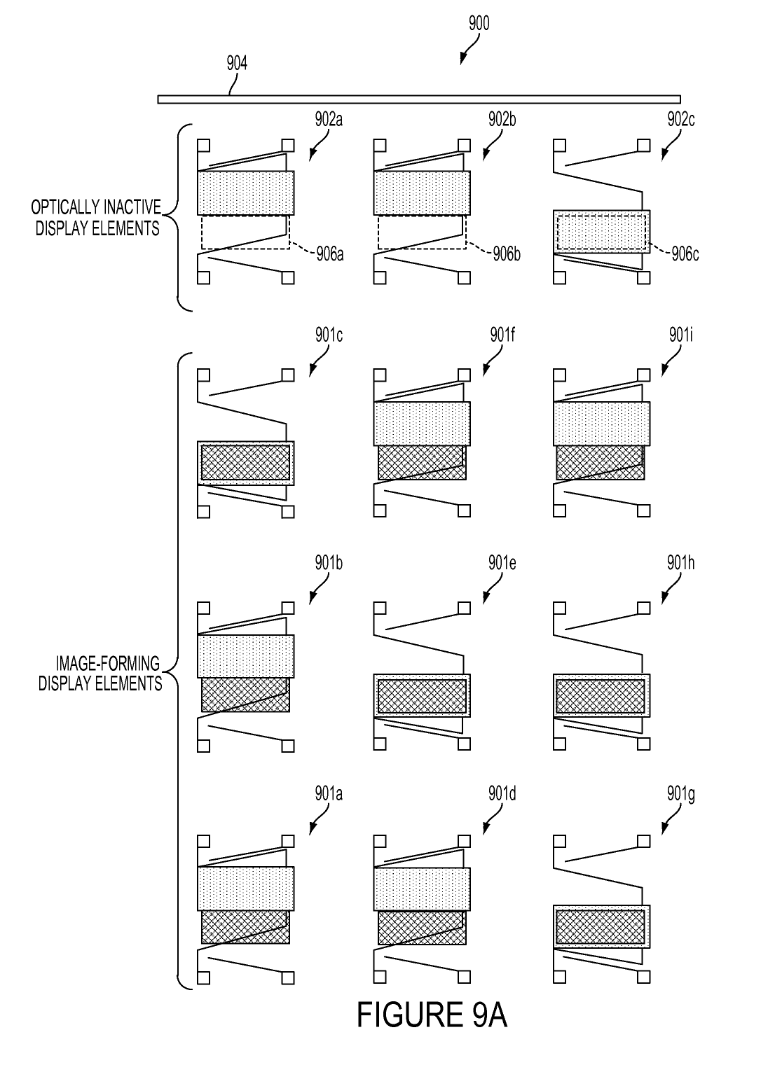

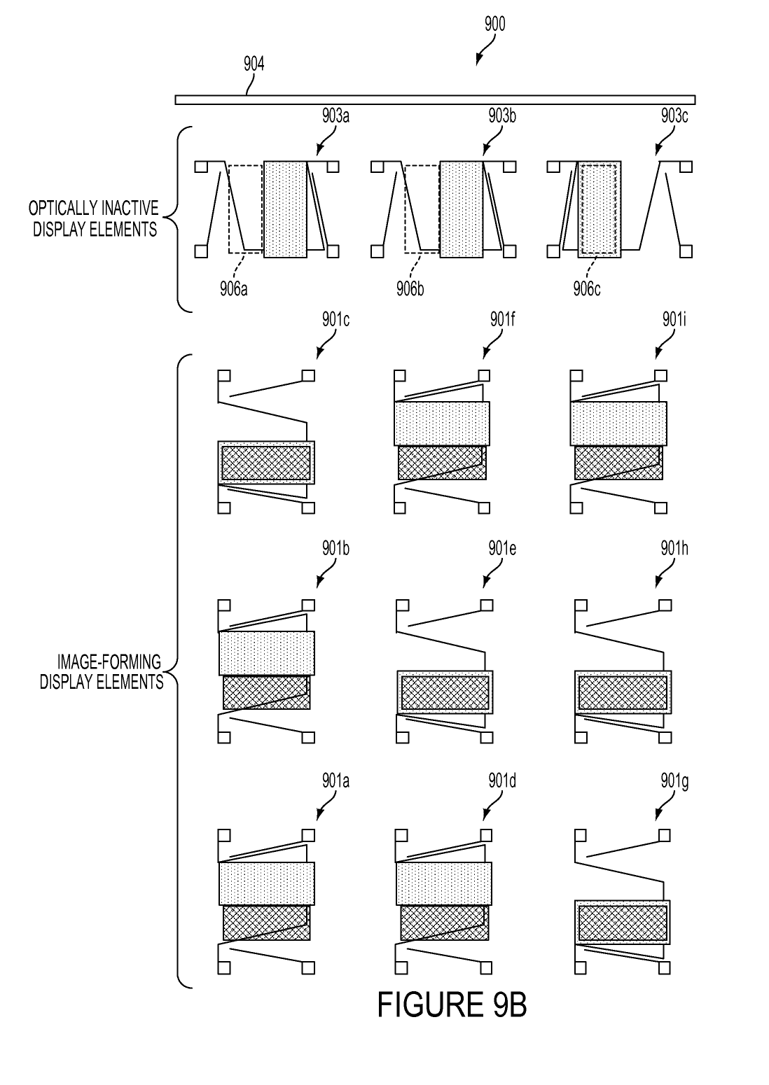

FIG. 9A shows an example top view of a portion of a display 900. The display 900 includes an array of image-forming display elements 901a-901i (generally referred to as image-forming display elements 901) and optically inactive display elements 902a-902c (generally referred to as optically inactive display elements 902) positioned beside an edge seal 904. The display elements shown in FIG. 9A represent only a portion of the display elements that may be present in a display apparatus, which in practice may include thousands or millions of such display elements. The image-forming display elements 901 and optically inactive display elements 902 are positioned in a 3×4 array. The seal 904 is positioned at the top of the array. In some implementations, the image-forming display elements 901 can be similar to the display elements 600 shown in FIGS. 6A-6C.

The optically inactive display elements 902 at the top of the array are not positioned within an image-forming region and do not contribute to the formation of images on the display 900. Therefore, the optically inactive display elements 902 are shown in FIG. 9A without apertures, so that they remain optically dark regardless of the position of their shutters. The broken lines 906a-906c mark the position where apertures could be placed if the optically inactive display elements 902a-902c, respectively, were intended to be used as image-forming display elements. Therefore, an optically inactive display element 902 whose shutter is positioned over the broken line 906 can be considered to be in a closed position, while an optically inactive display element 902 whose shutter is positioned outside of the broken lines 906 can be considered to be in an open position.

The position of the shutters of the image-forming display elements 901 is determined by the content of image data to be displayed. For example, the subframe generation logic 408 shown in FIG. 4 can determine a desired state for each of the image-forming display elements 901 based on image data received from a host device. In some implementations, the subframe generation logic 408 also can determine desired states for each of the optically inactive display elements 902. The desired states of the optically inactive display elements 902 can be selected based on the next state of one or more image-forming display elements 901.

Several algorithms can be used for determining a next state for each optically inactive display element 902. In some implementations, as shown in FIG. 9A, the state of each optically inactive display element 902 can be selected based on the most common state of the three image-forming display elements 901 in each respective column. For example, in the leftmost column, two image-forming display elements 901a and 901b are shown in the open position, while one image-forming display element 901c is shown in the closed position. Therefore, the optically inactive display element 901a in that column is selected to be in the open position. Similarly, in the middle column, two image-forming display elements 901d and 901f are shown in the open position, while one image-forming display element 901e is shown in the closed position. Therefore, the optically inactive display element 902b in that column is selected to be in the open position. Finally, in the rightmost column, two image-forming display elements 901g and 901h are shown in the closed position, while one image-forming display element 901i is shown in the open position. Therefore, the optically inactive display element 902c in that column is selected to be in the closed position.

In some implementations, other algorithms may be used to select the next state for each optically inactive display element 902. For example, the next state for each optically inactive display element 902 can be based on the next state of the single nearest image-forming display element 901. In other implementations, the next state for each optically inactive display element 902 can be based on a weighted average of the next states of the nearest image-forming display element 901, with greater weights applied to image-forming display elements 901 closer to the optically inactive display element 902. In some implementations, each column may include more than one optically inactive display element 902. In such implementations, the next state of each optically inactive display element can be determined independently from or in concert with the next state of other optically inactive display elements in the same column. In some implementations, the subframe generation logic 408 may determine that the optically inactive display elements 902 should not change state for one or more consecutive frames. For example, leaving the optically inactive display elements 902 at rest can reduce power consumption of the display 900. This may be desirable in situations where reducing power consumption is more beneficial than reducing the resistance experienced by image-forming display elements 901 at the edge of the display 900.

In some implementations, the next state for each optically inactive display element 902 can be selected based in part on the transition behavior of the image-forming display elements 901 from subframe to subframe. For example, the image-forming display elements 901 may be configured to maintain their prior state if their next state is the same as their prior state. An image-forming display element such as the image-forming display element 901c positioned at the edge of the viewing area and adjacent to the optically inactive display element 902a therefore may not change its state over two or more consecutive subframes. In this example, the image-forming display element 901c may not experience any resistance while it maintains its position and the optically inactive display element 902a does not have to be moved to reduce the resistance experienced by the shutter of the image-forming display element 901c. As a result, the next state for the optically inactive display element 902 can be selected based on the next state of other image-forming display elements such as image-forming display element 901b. For example, if a weighted average algorithm is used to select the next state for the optically inactive display element 902a, a weight of zero could be assigned to the image-forming display element 901c (as well as to any other image-forming display element 901 whose next state is the same as its previous state). Similarly, in some implementations, the image-forming display elements 901 may be configured to move to a closed state between consecutive subframes. Image-forming display elements 901 that are assigned to be in the closed state for two or more consecutive subframes therefore will not experience fluid resistance during those subframes, and the algorithm for determining the next state of the optically inactive display elements 902 can take this into account. In some other implementations, the image-forming display elements 901 can be configured to move to a neutral state (i.e., neither a closed state nor an open state) between consecutive subframes. In such an implementation, each image-forming display element 901 will experience fluid resistance during every subframe. Other transitional behavior for the image-forming display elements 901 also can be used, and can be factored into the algorithm chosen for selecting the next state of the optically inactive display elements 902.

In some implementations, the display 900 may include separate control interconnects for actuating the optically inactive display elements 902. For example, in some implementations, it may be desirable for the optically inactive display elements 902 to be actuated shortly before (for example, on the order of about 1-20 μs, such as 7-12 μs, earlier) the image-forming display elements are actuated. Doing so can begin the displacement of the fluid in the display 900, generating partial vacuum that can help pull the shutters of the image-forming display elements into their next state, speeding up their actuation. Moreover, because the optically inactive display elements 902 are optically inactive, their actuation need not be synchronized with the illumination of the display light sources, providing additional freedom in the timing of their actuation. To provide for earlier actuation of the optically inactive display elements 902, the display 900 can include a separate optically inactive display element global actuation interconnect (not shown), which can trigger actuation of the optically inactive display elements 902 independently from the image-forming display elements 901.

FIG. 9B shows another example top view of a portion of a display 910. Like the display 900 shown in FIG. 9A, the display 910 includes an array of image-forming display elements 901a-901i (generally referred to as image-forming display elements 901) and optically inactive display elements 903a-903c (generally referred to as optically inactive display elements 903) positioned beside an edge seal 904. The display elements shown in FIG. 9B represent only a portion of the display elements that may be present in a display apparatus, which in practice may include thousands or millions of such display elements. The image-forming display elements 901 and optically inactive display elements 903 are positioned in a 3×4 array. The seal 904 is positioned at the top of the array. The image-forming display elements 901 can be configured to move in a direction perpendicular to the edge seal 904, while the optically inactive display elements 903 can be configured to move in a direction parallel to the edge seal (and perpendicular to the direction of motion of the image-forming display elements 901).

Motion of the optically inactive display elements 903 in a direction perpendicular to the direction of the image-forming display elements 901 can help to reduce the fluid resistance experienced by image-forming display elements 901 near the edge of the display 900 by reducing the static pressure on the image-forming display elements 901. In some implementations, the subframe generation logic 408 shown in FIG. 4 can determine a desired state for each of the image-forming display elements 901 and the optically inactive display elements 903 based on image data received from a host device. For example, in some implementations, all of the optically inactive display elements 903 may be configured to move in the same direction simultaneously. Because the optically inactive display elements 903 move parallel to the edge seal 904, such simultaneous motion can be used to cause fluid flow around the perimeter of the display 904, which can reduce fluid forces on the image-forming display elements 901. In some other implementations, the optically inactive display elements 903 can be controlled to move additional fluid towards or away from some of the image-forming display elements 901 near the edge of the display 900. For example, when an image-forming display element 901 is controlled to move towards the edge seal 904, a nearby optically inactive display element 903 can be controlled to move fluid away from the image-forming display element 901, thereby reducing the resistance experienced by the image-forming display element 901. Similarly, when an image-forming display element 901 is controlled to move away from the edge seal 904, a nearby optically inactive display element 903 can be controlled to move fluid towards the image-forming display element 901 to increase the force applied to the image-forming display element 901 in the direction away from the edge seal 904.

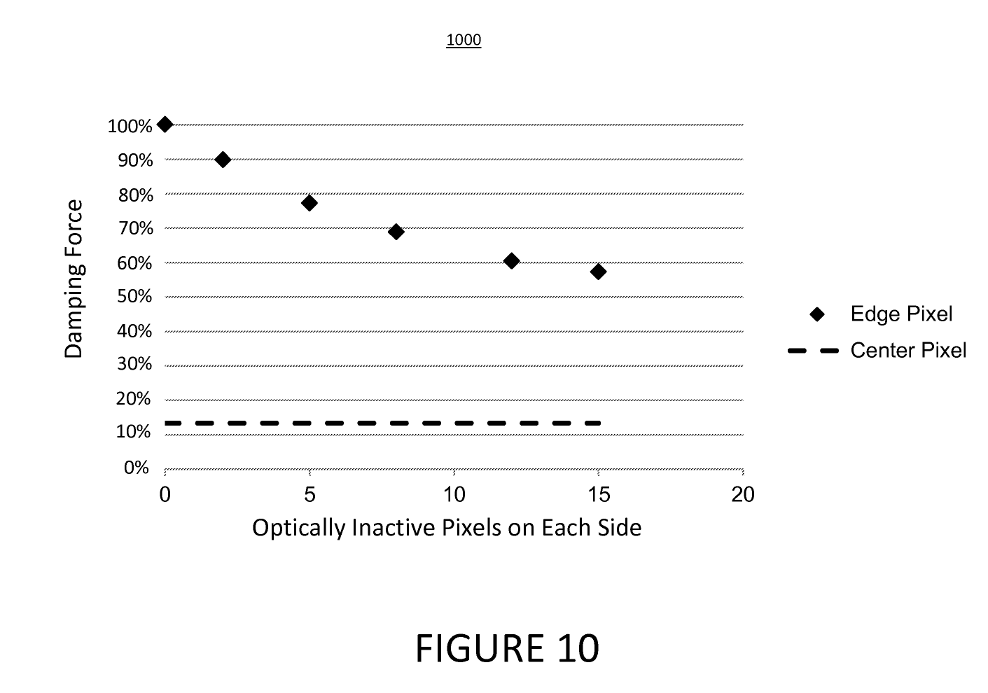

FIG. 10 shows a graph 1000 of the damping forces on display elements in an example display incorporating various numbers of optically inactive display elements at the edge of the display. The plots are generated for a simplified two-dimensional simulated display having a display-to-bond width of about 2 millimeters and display elements having shutters with a frontal length of about 74 microns. Because the simulated display is two-dimensional, effects of the cell gap are ignored. As discussed above in connection with FIG. 7, the display elements in the center of the display tend to experience substantially constant damping forces. The edge display elements, however, experience substantially greater damping forces. The graph 1000 demonstrates that the damping forces experienced by the display elements at the edge of the display can be reduced by incorporating active optically inactive display elements. The simulated display used to generate the graph 1000 represents only one example of a display that may benefit from the concepts described herein.

The y-axis of the graph 1000 is normalized to the damping force experienced by an edge pixel in a display having no optically inactive pixels. While the particular forces on display elements may vary based on these characteristics, the general principle illustrated in the graph 1000 can apply to any display having MEMS-based display elements. As shown in the graph 1000, the average damping force experienced by the display elements at the edge of the image-forming region decays exponentially as a function of the number of optically inactive display elements incorporated into the display. For example, incorporating 5 optically inactive display elements on each side of the display can reduce the damping forces on the display elements at the edge of the image-forming region to less than about 80% of the force experienced by the display elements at the edge of the image-forming region without optically inactive display elements. Incorporating 15 optically inactive display elements on each side of the display can reduce the damping force experienced by display elements at the edge of the image-forming region to less than about 60% of the force experienced by the display elements at the edge of the image-forming region without optically inactive display elements.

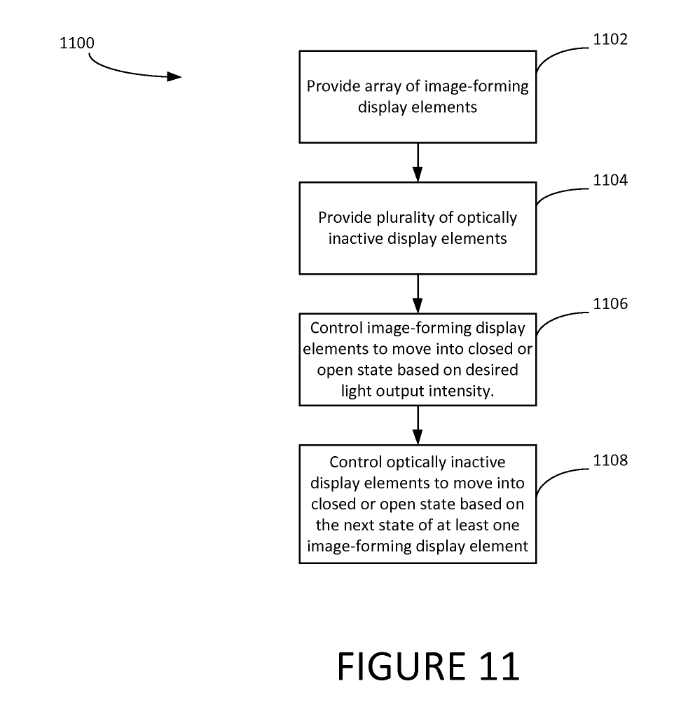

FIG. 11 shows a flow diagram of an example method 1100 for displaying an image on a display apparatus. The method 1100 includes providing an array of display elements (stage 1102). The method 1100 includes providing a plurality of optically inactive display elements (stage 1104). The method 1100 includes controlling the display elements to move into closed or open states based on a desired light output intensity (stage 1106). The method 1100 includes controlling the optically inactive display elements to move into first or second states based on the next state of at least one display element (stage 1108).

Referring again to FIG. 11, the method 1100 includes providing an array of display elements (stage 1102). The array of display elements can define an image-forming region of a display apparatus. Each display element can include a suspended movable component capable of controlling a light output intensity. For example, the display elements can be shutter-based display elements as shown above in FIGS. 2A-2B or FIGS. 6A-6C. The suspended movable components of each display element may include a shutter capable of moving laterally with respect to a rear aperture and a front aperture to allow a desired amount of light to pass from the rear aperture through the front aperture. The display elements can be arranged in columns and rows to form a substantially rectangular image-forming region. In some implementations, the display elements are configured so that their suspended movable components all move along substantially the same axis.

The method 1100 includes providing a plurality of optically inactive display elements (stage 1104). The optically inactive display elements are positioned outside of the image-forming region. For example, the optically inactive display elements may be positioned at the ends of each row or column of the array of image-forming display elements. In some implementations, the optically inactive display elements are positioned at the ends of a row or column in the direction of movement of the suspended movable components, as shown in FIGS. 8A and 8B. Each row or column may include one or more optically inactive display elements at the perimeter of the image-forming region. For example, each row or column may include 1, 2, 5, 10, 15, 20, 25, 30, or more optically inactive display elements at the perimeter of the image-forming region.

The method 1100 further includes, for each display element, controlling the movable component of the display element to move into a closed state or an open state to control an output light intensity corresponding to a pixel of the image (stage 1106). In some implementations, the movable component can be a shutter positioned between a front aperture and a rear aperture. The shutter can be moved laterally into and out of an optical path between the front and rear apertures. The position of the shutter can be selected to control an intensity of light that is to be permitted to pass from the rear aperture through the front aperture. For example, a backlight may be positioned behind the rear aperture. A shutter of a display element may be moved out of the optical path between the front aperture and the rear aperture to allow a relatively high intensity of light to pass from the rear aperture through the front aperture. The shutter may be moved to obstruct the optical path to allow a relatively low intensity of light pass from the rear aperture through the front aperture. In some implementations, the desired light output intensity selected for each display element can be based on the image to be displayed. For example, each display element can correspond to a pixel of the image.

For each optically inactive display element, the movable component of the optically inactive display element is controlled to move into a first state or a second state based on a next state of at least one display element (stage 1108). In some implementations, the optically inactive display elements are controlled to displace a substantially incompressible fluid in order to reduce the resistance experienced by the movable components of the display elements. For example, an optically inactive display element can be controlled to move into a next state based on the next state of an adjacent display element. In some implementations, the next state of the optically inactive display element may be the same as the next state of the adjacent display element. This can cause the movable component of the optically inactive display element to move (and therefore to displace fluid) in the same direction as the movable component of the adjacent display element. Therefore, the display element can move more freely through the fluid. In some implementations, the next state of each optically inactive display element can be based on the next states of two or more display elements. For example, the next state of each optically inactive display element can be selected based on an average or weighted average of the next states of the nearest two or more display elements. In some implementations, the optically inactive display elements are controlled to move into their designated states simultaneously with the display elements moving to their respective next states. In some implementations, the optically inactive display elements are controlled to move into their designated states slightly ahead of the time at which the display elements move into their respective next states. For example, the optically inactive display elements can be controlled to move about 1-20 μs before the display elements. In some implementations, the optically inactive display elements can be controlled to move about 7-12 μs before the display elements.

FIGS. 12A and 12B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming In addition, the housing 41 may be made from any of a variety of materials, including, but not limited to: plastic, metal, glass, rubber and ceramic, or a combination thereof The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 12A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a rear substrate;
a front substrate positioned in front of the rear substrate;
a seal coupling the rear substrate and the front substrate;
an array of display elements positioned between the front substrate and the rear substrate to form an image-forming region, each display element including a movable component;
a plurality of optically inactive display elements positioned outside of the image-forming region, each optically inactive display element including a movable component;
a fluid surrounding the display elements and the optically inactive display elements and filling a volume defined by the rear substrate, the front substrate, and the seal; and
a controller capable of:
obtaining a next state for each display element based on image data;
determining a next state for each optically inactive display element based on the next state of at least one display element; and
outputting control signals capable of causing the movable components of each display element and each optically inactive display element to move into the respective next state.

2. The apparatus of claim 1, wherein the optically inactive display elements are capable of being optically dark regardless of the state of their respective movable components.

3. The apparatus of claim 1, wherein a shape of the movable components of the display elements is substantially identical to a shape of the movable components of the optically inactive display elements.

4. The apparatus of claim 1, wherein the fluid is an electrically non-conductive oil.

5. The apparatus of claim 1, wherein the optically inactive display elements are positioned away from the seal by a distance in the range of about 0.1 millimeters to about 4 centimeters.

6. The apparatus of claim 1, wherein the front substrate is separated from the rear substrate by a distance in the range of about 7 microns to about 15 microns.

7. The apparatus of claim 1, wherein the display elements and optically inactive display elements are arranged in rows and columns along axes of the apparatus.

8. The apparatus of claim 7, wherein the movable components of each display element and each optically inactive display element are capable of moving substantially parallel to one of the axes.

9. The apparatus of claim 7, wherein the movable components of each display element are capable of moving parallel to one of the axes and the movable components of each optically inactive display element are capable of moving substantially perpendicular to such axis.

10. The apparatus of claim 7, wherein the optically inactive display elements are positioned at ends of each row or column on either side of the image-forming region.

11. The apparatus of claim 7, wherein each row or column includes between 1 and about 15 optically inactive display elements on either side of the image-forming region.

12. The apparatus of claim 1, wherein for each optically inactive display element, the next state of the optically inactive display element is selected to be the same as the next state of the display element closest to the optically inactive display element.

13. The apparatus of claim 1, wherein for each optically inactive display element, the next state of the optically inactive display element is selected based on an average of the next states of the two or more display elements closest to the optically inactive display element.

14. The apparatus of claim 1, wherein the optically inactive display elements are capable of being actuated earlier than the display elements.

15. The apparatus of claim 1, further comprising:
a display including the apparatus;
a processor that is capable of communicating with the display, the processor being capable of processing image data; and
a memory device that is capable of communicating with the processor.

16. The apparatus of claim 15, further comprising:
a driver circuit capable of sending at least one signal to the display; and
a controller capable of sending at least a portion of the image data to the driver circuit.

17. The apparatus of claim 15, further comprising:
an image source module capable of sending the image data to the processor, wherein the image source module includes at least one of a receiver, transceiver, and transmitter.

18. The apparatus of claim 15, further comprising:
an input device capable of receiving input data and communicating the input data to the processor.

19. A method for displaying an image on a display apparatus, comprising:
providing an array of display elements forming an image-forming region, each display element including a movable component capable of controlling a light output intensity;
providing a plurality of optically inactive display elements positioned at the perimeter of the image-forming region;
for each display element, controlling the movable component of the display element to move into a closed state or an open state to control an output light intensity corresponding to a pixel of the image; and
for each optically inactive display element, controlling the movable component of the optically inactive display element to move into a first state or a second state based on a next state of at least one display element.

20. The method of claim 19, wherein the display elements and optically inactive display elements are arranged in rows and columns aligned axes of the display apparatus, the method further comprising:
for each optically inactive display element, controlling the movable component to move into an first state or a second state based on an average of the next states of two or more display elements closest to the optically inactive display element.

21. The method of claim 19, wherein controlling the movable component of each optically inactive display element comprises controlling the movable component to displace a fluid surrounding the display elements and the optically inactive display elements away from an adjacent display element.

22. An apparatus comprising:
a rear substrate;
a front substrate positioned in front of the rear substrate;
a seal coupling the rear substrate and the front substrate;
an array of display elements positioned between the front substrate and the rear substrate to form an image-forming region, each display element including a movable component;
a fluid surrounding the display elements and filling a volume defined by the rear substrate, the front substrate, and the seal; and
a fluid displacement means for displacing the fluid to reduce a force experienced by the movable component of at least one display element.

23. The apparatus of claim 22, further comprising:
a controller capable of determining a next state for the fluid displacement means based on a next state of the display element.

24. The apparatus of claim 22, wherein the next state for the fluid displacement means is selected to be the same as the next state of the display element closest to the fluid displacement means.

25. The apparatus of claim 22, wherein the fluid displacement means is capable of displacing fluid earlier than the display elements.
